(19) United States
(12) Patent Application Publication
(10) Pub. No.: US 2019/0239481 A1
(43) Pub. Date: Aug. 8, 2019

(54) PET TOY WITH BENDABLE CENTER ROD AND CONCENTRIC BALL TRACKS

(71) Applicant: Elizabeth Bentz, Denver, CO (US)

(72) Inventor: Elizabeth Bentz, Denver, CO (US)

(21) Appl. No.: 15/892,326

(22) Filed: Feb. 8, 2018

(51) Int. Cl. A01K 15/02

(52) U.S. Cl. CPC A01K 15/025

(57) ABSTRACT

The invention is a novel pet toy wherein a base piece has a rounded bottom and two concentric tracks where a pet owner can insert a ball or a set of balls into the tracks. The rounded bottom allows the toy to wobble to any angle yet not topple over. The wobbling action causes the balls to move and to continue moving until the toy rests to one side. A two-ball set connected by a fabric strip can be placed one in each track and will travel in unison within each of the two tracks. A malleable center rod has a feather or other attractant at its tip for further interaction and interest by a pet.

### FIELD

The present invention relates generally to stimulating, encouraging and motivating games and methods of playing regarding pets, e.g. dogs and cats. More particularly, the invention relates to motivational games, toys and methods for assessing the pet training skills in the form of games or puzzles that incite pet interaction and memory skills.

### PRIOR ART

There are many pet toys on the market, and many toys that have a base piece and some form of internal track, corrugated scratch pads, or other forms of stimuli for a pet within a base. All of these toys tend to lay flush to a surface and as such are designed to remain in a fixed position. The inventive toy is novel in that it does not lay flat on a surface, but rather has a rounded bottom so it “wobbles” in any direction when a pet manipulates the toy.

### BRIEF DESCRIPTION OF THE INVENTION

Since the base piece is rounded on the bottom, any balls within the tracks will continue to traverse the tracks as a result of gravity and centrifugal force. The toy offers a two-ball set wherein the balls are attached to one another with a fabric strip and can be placed one in each track, and thus the balls will move in relative unison.

The object of the present invention is to motivate and maintain interest of a pet with the toy's movement and attached methods of stimuli in addition to the wobbling motion and the balls traversing the tracks. The attachment is a bendable center rod that includes stimuli such as feathers or a ball atop the center rod.

The present toy will wobble in any direction when either a pet is playing with the toy, or whether it is moving as a result of residual response to a ball or balls still traversing the tracks. The rounded bottom causes the toy to wobble, and thus the ball will use gravity to travel in either of the two tracks. This extended movement, and combination of features has been shown to significantly aid in attaining and retaining a pet's interest.

A bendable center rod is located in the center of the toy. Located in the center of the toy, this bendable rod is also designed to maintain a certain level of movement after initial manipulation by a pet. The rod can be made of either a coated spring or simply a twisted material such as nylon to be sturdy, yet malleable. A feather top or ribbons or other attractants are connected to the rod at the top and provide further entertainment for the pet. The balls which travel around the tracks contain sparkling glitter inside the ball or have a faux suede “tail” which further interests a pet. Especially a cat. Further advantages and aspects of the invention will be evident from the detailed description below

### BACKGROUND OF THE INVENTION

The invention most closely corresponds with USPTO Class 119/707 wherein Class 119 relates to animal husbandry and sub-class 707 includes toys, lures, fetch and related devices.

In its simplest form, the invention relates to a novel toy for pets which is designed to create an interest and entertain a pet without constant human interaction wherein the toy will move in response to touch and continue to move causing a pet to be further motivated to play with the toy.

### The Invention

### SUMMARY, OBJECTS AND ADVANTAGES

It well known that pets do experience a sense of boredom, and if not addressed, may manifest in negative behavior such as chewing furniture or going to the bathroom in undesirable locations in the pet owner's home. The inventive toy is designed to capture and retain a pet's interest whether the pet owner is away or home. The pet owner can manipulate the toy in some way to actively play with the pet as well. The toy is not designed to “replace” human interaction, but rather to help keep a pet entertained even if the owner is not also interacting with the toy and pet.

The inventive toy is comprised of a plastic body with a rounded base with two concentric circular tracks wherein a ball or multiple balls can rotate around the tracks. For the purposes herein, we will describe the tracks as the “inner track” and the “outer track” as the tracks are concentric to one another. The rounded base causes the entire toy to wobble in any direction, and the ball or balls will continue to travel through the track as the toy wobbles. The center rod responds to touch and will also continue to wobble in any direction when a pet swipes at the rod. The rod can have a ball, feathers, ribbons or other stimuli atop the rod which serve to make the center rod piece more alluring to a pet.

### BRIEF DESCRIPTION OF THE DRAWINGS

The invention is described in further detail by reference to five (5) drawings sufficient in detail to describe the invention in which:

FIG. 1 is a perspective of the toy showing the tracks and center rod;

FIG. 2 is an exploded view of the toy;

FIG. 3 is a side transparent perspective of the toy;

FIG. 4 is a side perspective and close up of the center rod with feather; and

FIG. 5 is a sampling of the balls.

### DETAILED DESCRIPTION, INCLUDING BEST MODES OF CARRYING OUT THE INVENTION

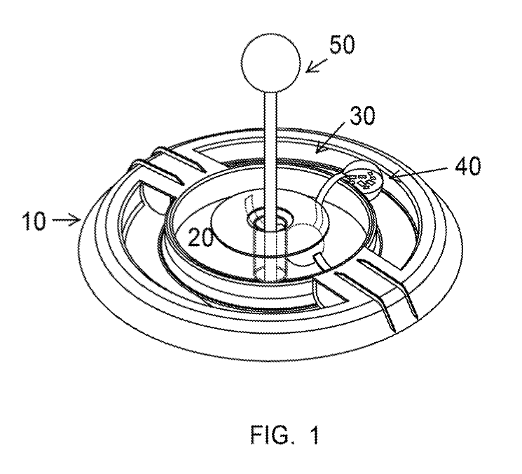

FIG. 1 shows the entire toy with the base 10 containing two tracks. The inner track 20 encircles the entire base piece and allows for balls to be rolled within this track. The outer track 30 is similarly placed within the base and allows balls to be rolled within its track. In this Figure, a set of balls is shown as attached to one another with a strip of fabric 40 so that a pet owner can have a ball in each track that will move in unison with one another. Conversely, a single ball can be used as would be an obvious modification of this double-ball embodiment. The center rod 50 is connected to the base and is malleable in response to pet contact. In this embodiment a ball is atop the center rod, but as disclosed herein, this can be topped with a feather or other attractant.

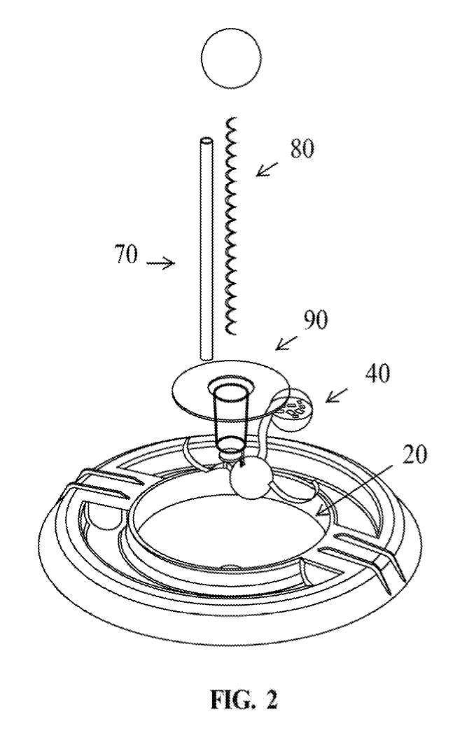

FIG. 2 is an exploded view of the toy wherein the center rod 50 is shown as either having a spring member 70 within it, or simply made of a bendable material 80 sufficient to stand straight, but also be malleable so that the rod responds to pet manipulation. In this view, a center section 90 is shown detached to illustrate how both the center rods may be mounted, and to create the inner track 20 of the toy. Again, a set of balls 40 is shown as attached to one another with a fabric strip and will travel within the inner and outer tracks. This embodiment can also include only having a single ball, i.e. unattached to one another to travel within either or both tracks.

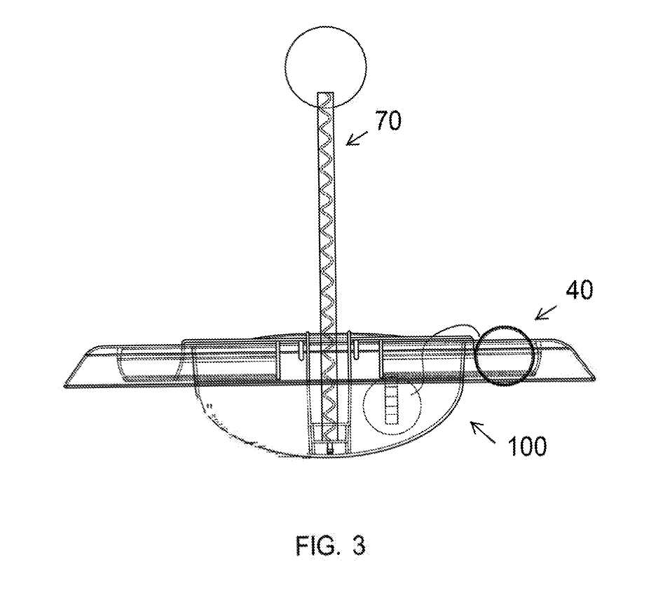

FIG. 3 is a transparent view of the toy detailing the base bottom 100. The arched shape of the base bottom allows for the toy to “wobble” in any direction when manipulated by a pet. As the toy wobbles, any balls within the racks 40 will also respond to the movement and the ball or balls will traverse the track. The center rod is again shown with a spring 70 center allowing the rod to bend in response to pet manipulation as well. Again, this is only one embodiment of the center rod.

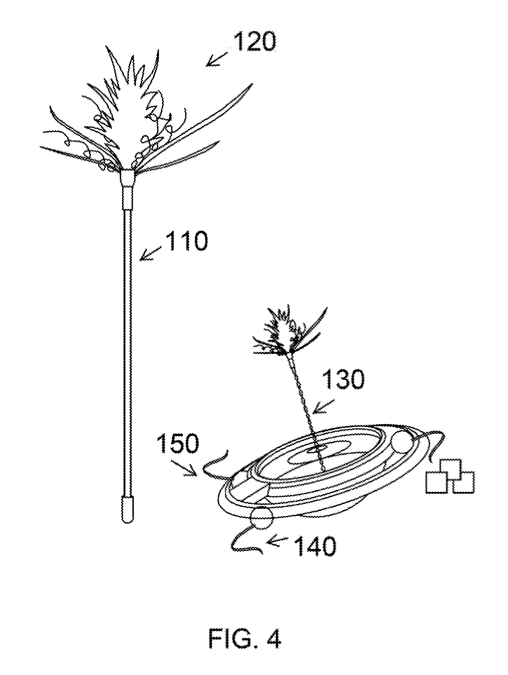

FIG. 4 shows a second preferred embedment wherein the center rod is comprised of a feather piece atop the rod 120, wherein this rod can be a bendable nylon 110, or a twisted nylon pair 130. In either case, the center rod is malleable and responds to animal manipulation, and wherein the feather is an additional attractant for the pet. In this view, single balls with fabric tails 140 are shown in the toy tracks. These balls can move independent of one another within the two separate tracks, and wherein the “tail” 150 is a strip of fabric designed to engage the pet with it's motion as the ball traverses the track.

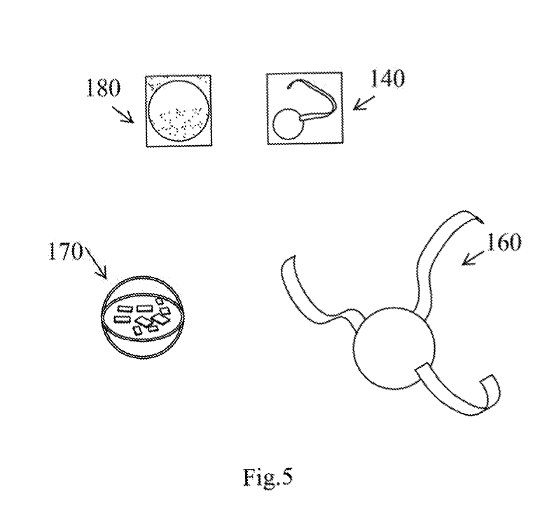

FIG. 5 is a sampling of the balls that may be used in the tracks. The single tail 140 ball is again illustrated. Optional balls include a ball with three tails 160 which can be placed in either track. Another ball of choice may be a hollow transparent ball 170 with some form of small matter that will circulate inside the ball when moving. The matter may be glitter or small pieces of plastic. In either case, the movement and sound of the matter inside the ball is an additional attractant for the pet. Finally, the ball may be light rubber or plastic 180 and be without tails or internal matter.

1) A pet toy comprising:
a) A circular base piece with a rounded bottom and two concentric tracks located within the circular base piece wherein the toy will lean to any side in a 360 degree radius according to gravitational pull as a result of pet manipulation or the weight of a ball in one or both of the concentric tracks;
b) A first inner track which encircles the circumference of the base piece and can receive a single ball, or one of two balls connected by a strip of fabric wherein the second ball traverses a second track;
c) A second outer track which encircles the circumference of the base piece concentric to the first inner track, and can receive a single ball or one of two balls connected by a strip of fabric;
d) A center rod affixed to the base piece wherein the rod is malleable and has feathers, a ball or other attractant device atop the rod;
e) A set of balls to be placed within the first or second tracks wherein the balls are attached to one another by a strip of fabric;

2) A pet toy as in claim 1 wherein the rounded bottom of the base piece allows for the toy to rock in any direction and will rest listing to a side in response to manipulation by a pet or by the weight of a ball or balls in either or both tracks, and wherein the toy will not completely turn over as prevented by an outer lip of the base piece.

3) A pet toy as in claim 1 wherein a first inner track is located near the center rod and encircles the circumference of the base and wherein a single ball or one of two balls which are connected by a strip of fabric can traverse the track wherein the first of two balls connected by a fabric strip traverse the inner track.

4) A pet toy as in claim 1 wherein a second outer track is located in the base piece and is concentric to the inner track wherein a single ball may be placed, or one of two balls connected by a fabric strip wherein the second ball traverses the outer track while the first ball traverses the inner track in unison with one another.

5) A ball set for traversing the tracks of the pet toy wherein the ball set has strips of fabric to connect two balls together so as to traverse the tracks of the toy.
